(19) United States
(12) Patent Application Publication
(10) Pub. No.: US 2011/0198202 A1
(43) Pub. Date: Aug. 18, 2011

(54) MEMS-BASED ULTRA-LOW POWER DEVICES

(75) Inventor: John E. Rogers, Vero Beach, FL (US)

(73) Assignee: Harris Corporation, Melbourne, FL (US)

(21) Appl. No.: 12/708,265

(22) Filed: Feb. 18, 2010

(51) Int. Cl. H01H 57/00

(52) U.S. Cl. 200/181

(57) ABSTRACT

A gap closing actuator (GCA) device (200) is provided. The GCA device includes at least one device drive comb structure (202a, 202b), at least one input/output (I/O) comb structure (216a, 216b) defining an output of the GCA device, and at least one device truss comb structure (204) interdigitating the device drive comb structure and the I/O comb structure, the truss comb structure configured to move along a first motion axis (205) between a plurality of interdigitated positions based on a first bias voltage (V_{BIAS}) applied between the truss comb structure and the device drive comb structure. The GCA device also includes a brake portion (230) configured for selectively physically engaging the device truss comb structure to fix a position of the device truss comb structure along the first motion axis.

### FIELD OF THE INVENTION

The present invention relates to micro-electro-mechanical system (MEMS) and methods for forming the same, and more specifically to ultra-low power MEMS devices.

### BACKGROUND

In general, telecommunications devices include a combination of electronic elements, including switches, capacitors, and inductors. Although some telecommunications devices can be configured to utilize a combination of discrete elements, other telecommunications devices can be configured to include these electronic elements in one or more integrated circuits. For example, these electronic elements can be provided via a combination of metal oxide semiconductor (MOS) transistors, diodes, and capacitors, PIN diodes, and/or bipolar junction transistors (BJTs). However, as the functionality of telecommunications devices has increased, the number of electronic elements needed in an integrated circuit has increased exponentially. As a result, each generation of integrated circuits generally requires an amount of power significantly higher than its predecessor.

### SUMMARY

Embodiments of the invention provide methods for fabricating ultra-low power micro-electro-mechanical system (MEMS) devices and devices therefrom. In a first embodiment of the invention, a gap closing actuator (GCA) device is provided. The GCA device includes at least one device drive comb structure, at least one input/output comb (I/O) structure defining an output of the GCA device, and at least one device truss comb structure interdigitating the device drive comb structure and the I/O comb structure. The device truss comb structure is configured to move along a first motion axis between a plurality of interdigitated positions based on a first bias voltage applied between the truss comb structure and the device drive comb structure. The GCA device also includes a brake portion configured for selectively physically engaging the device truss comb structure to fix a position of the device truss comb structure along the first motion axis.

In a second embodiment of the invention, a method of manufacturing micro-electro-mechanical (MEMS) device is provided. The method includes providing a substrate having a stack of layers including at least one base layer, at least one release layer on the base layer, and at least one structure layer on the release layer. The method also includes depositing at least one electrically conductive layer on the structure layer. The method further includes forming a plurality of voids in the electrically conductive layer, the structure layer, and the release layer to define a plurality of patterned regions. The patterned regions define at least one device drive comb structure, at least one input/output (I/O) comb structure, at least one device truss comb structure interdigitating the device drive comb structure and the I/O comb structure, and a brake portion. In the method, the forming step further includes selecting the plurality of voids to further configure said device truss comb structure for selectively moving along a first motion axis between a plurality of interdigitated positions and to further configure the brake portion for selectively moving to physically engage the device truss comb structure.

In a third embodiment of the invention, a system is provided. The system includes a plurality of GCA devices. Each of the plurality of GCA devices includes at least one device drive comb structure, at least one I/O comb structure defining an output, and at least one device truss comb structure interdigitating the device drive comb structure and the I/O comb structure, where the device truss comb structure configured to move along a first motion axis between a plurality of interdigitated positions based on a first bias voltage applied between the device truss comb structure and the device drive comb structure. Each of the GCA devices also includes a brake portion configured for selectively physically engaging the device truss comb structure to fix a position of the device truss comb structure along the first motion axis. The system further includes a control element configured for providing the first and the second bias voltages to the GCA device.

### BRIEF DESCRIPTION OF THE DRAWINGS

FIG. 1 shows a drive portion of a MEMS horizontal device in accordance with an embodiment of the invention.

FIG. 2 shows a top view of an exemplary MEMS comb device which can be adapted for use as one or more types of devices in a filter bank in accordance with an embodiment of the invention.

FIGS. 3A-3C show partial cross-sections of the device in FIG. 2 through cutline 3-3 during various steps of a fabrication process in accordance with the various embodiments of the invention.

FIG. 4 shows a top view of an exemplary MEMS comb device adapted for use as a horizontal GCA switch device in accordance with an embodiment of the invention.

FIG. 5 shows a top view of an exemplary MEMS comb device adapted for use as a horizontal GCA varactor device in accordance with an embodiment of the invention.

FIG. 6 is a schematic diagram of a system including MEMS comb devices in accordance with the various embodiments of the invention.

### DETAILED DESCRIPTION

The present invention is described with reference to the attached figures, wherein like reference numerals are used throughout the figures to designate similar or equivalent elements. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operations are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

As described above, one of the problems with conventional integrated circuit (IC) development is the increasing amount of power needed for each generation of ICs. In general, this problem arises because MOS, PIN diode, and BJT devices typically operate in response to an active signal. That is, unless a signal is actively provided to the device, it will not generally function. For example, in the case of complementary MOS devices, when a MOS transistor is used as a switch, closing of the switch (i.e., allow a current to flow) typically requires that a voltage be applied to the gate electrode of the MOS transistor. Further, to maintain the switch in the closed position, the voltage needs to be maintained. As a result, a significant amount of power is used to maintain the MOS transistor in a closed state. PIN diode and BJT devices operate in a similar fashion. An additional problem with the use of MOS, PIN diode, and BJT devices is that these devices generally provided limited performance in telecommunications applications. In general, solid state devices generally provide a path for signals, even when not active. As a result, poor isolation of signals is common for such devices resulting in increased noise and interference. Therefore, in order to reduce power requirements and address signal isolation issues in IC-comprising telecommunications, it has been proposed that telecommunications devices be fabricated using micro-electro-mechanical system (MEMS) technologies. In MEMS devices, the operation of the device is generally based on mechanical motion and therefore improved isolation can be achieved by designing the MEMS switch to physically separate components in the IC.

However, telecommunications ICs including conventional MEMS switch and capacitor devices are typically difficult to fabricate. In particular, conventional MEMS-based switches and conventional MEMS-based capacitors generally have significantly different geometries, requiring more complex processes and designs to successfully form both types of devices on the same substrate. This typically results in manufacturing techniques with smaller process margins, increasing overall development and manufacturing costs. Further, even though such MEMS-based switches and capacitors generally consume the less power than MOS, PIN diode, and BJT devices, the difference in power consumption is typically insignificant. In particular, MEMS-based devices, like their MOS, PIN-diode, or BJT device counterparts, generally require an active signal to operate. Accordingly, even though improved isolation is provided, power consumption is generally not significantly reduced.

In order to overcome the various limitations of conventional MEMS devices, embodiments of the invention provide systems and methods for providing ICs with ultra-low power MEMS devices. In the various embodiments of the invention, these MEMS devices are designed to have common geometries to reduce overall complexity and costs of fabricating ICs including such MEMS devices. In particular, the various embodiments of the invention utilize MEMS horizontal gap closing actuator (GCA) devices with common geometries to form switches devices, adjustable capacitors, and other devices. Further, to provide ultra-low power operation of such MEMS devices, a brake portion is provided in the devices for mechanically fixing a position of the moving portions of these MEMS devices without the need for maintaining an active signal. Thus, MEMS devices in accordance with an embodiment of the invention use significantly less power than conventional MEMS, MOS, PIN diode, and BJT devices.

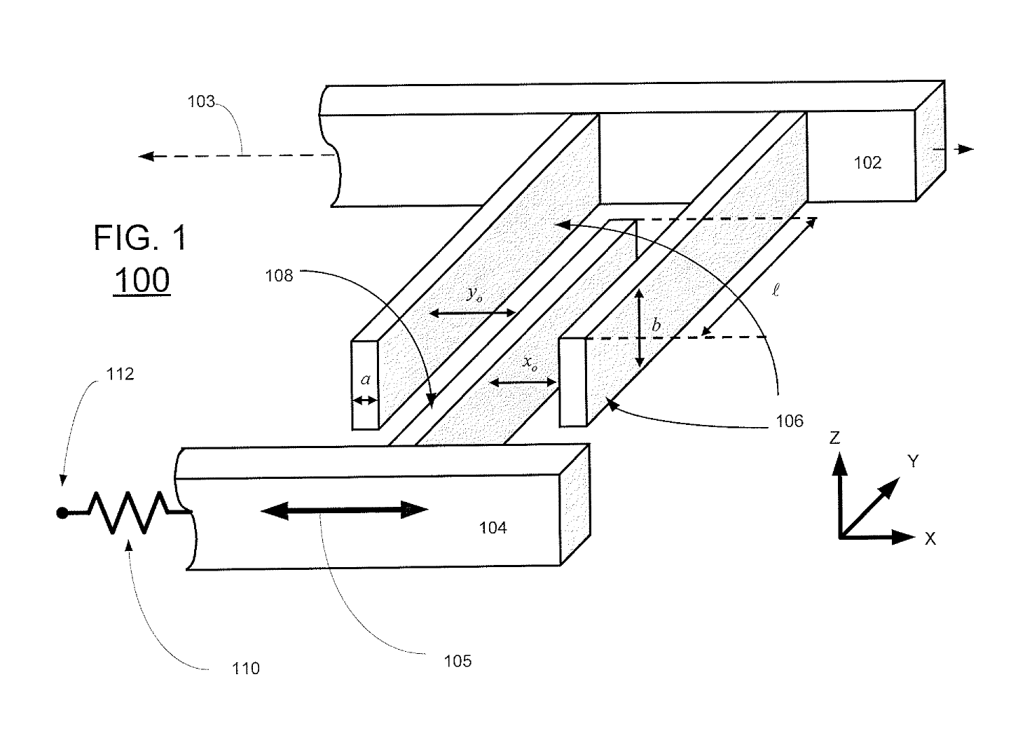

As used herein with respect to MEMS devices, the term “horizontal GCA device” refers to a GCA MEMS device in which actuation and interaction of the components in the MEMS device is limited to directions parallel to the supporting substrate. That is, actuation of the horizontal GCA device results in a substantially lateral motion. Consequently, the horizontal MEMS devices can be fabricated with one or two masks rather than the multiple masks (>2) typically required for conventional IC or MEMS devices. This reduces the overall complexity for designing and manufacturing MEMS-based devices, such as telecommunications ICs. Furthermore, horizontal MEMS GCA devices in accordance with the various embodiments of the invention can be easily modified to provide various types of devices, such as switches and adjustable capacitors (i.e., varactors), without significantly affecting operation or manufacture of such devices. The basic operation and manufacture of horizontal GCA devices in accordance with the various embodiments of the invention is described below with respect to FIGS. 1, 2, and 3A-3C.

FIG. 1 shows a drive portion 100 of a MEMS horizontal GCA device in accordance with an embodiment of the invention. Drive portion 100 includes a drive comb structure 102 having a fixed position and extending along a longitudinal axis 103. Drive portion 100 also includes a truss comb structure 104 that extends substantially parallel to axis 103 and that can elastically move along the X direction along a motion axis 105 substantially parallel to axis 103 of drive comb structure 102. For example, as shown in FIG. 1, truss comb structure 104 can include or be attached to at least one restorative or elastic component 110 connected to a fixed end 112. The elastic component 110 restores a position of truss comb structure 104 when no external forces are being applied. The drive comb structure 102 can have one or more drive fingers 106 extending therefrom towards truss comb structure 104. The truss comb structure 104 can similarly include one or more truss fingers 108 extending therefrom towards drive comb structure 102.

As shown in FIG. 1, the drive comb structure 102 and the truss comb structure 104 can be positioned to be interdigitating. The term “interdigitating”, as used herein with respect to comb structures, refers to arranging comb structure such that the fingers extending from such comb structures at least partially overlap and are substantially parallel.

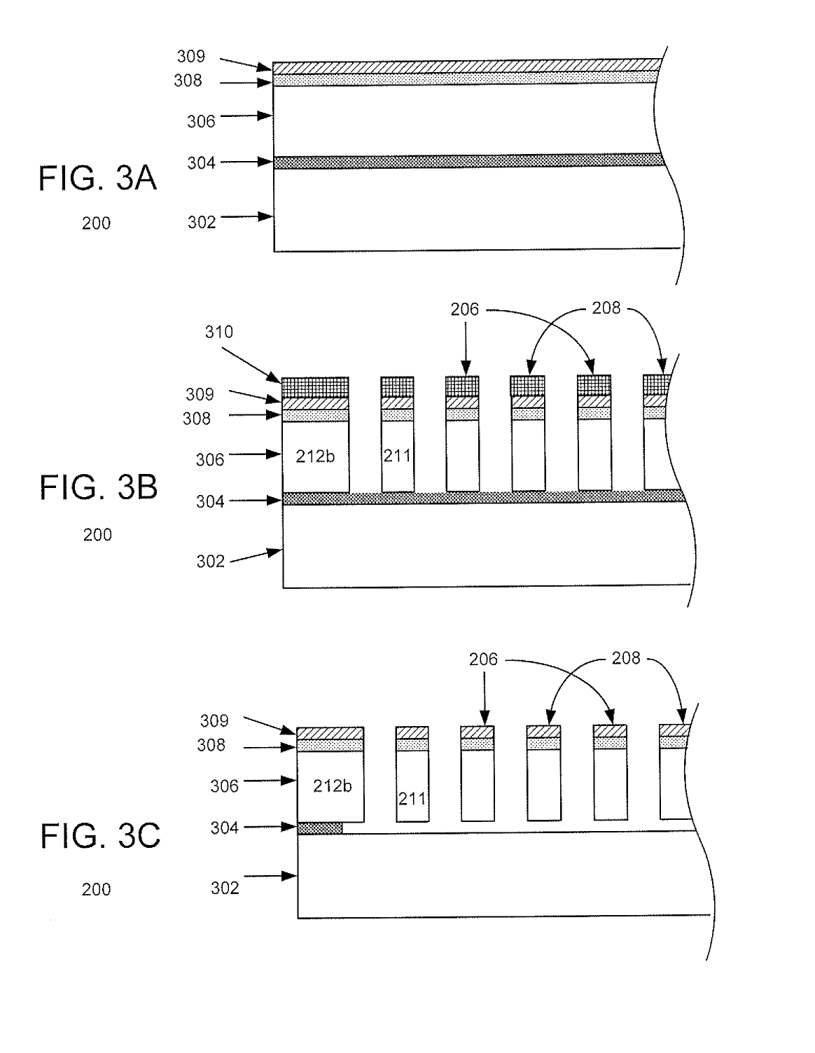

In the embodiment shown in FIG. 1, fingers 106 and 108 each have a width and a height of a and b, respectively, and overlap of 1. Although comb structures with multiple sets of fingers can be configured to have the same dimensional relationships (width, height, and overlap) the invention is not limited in this regard and dimensional relationships can vary, even within a single GCA device. Furthermore, the portion shown in FIG. 1 and the dimensional relationship shown in FIG. 1 are only the electrically conductive portions of drive portion 100. As one of ordinary skill in the art will recognize, comb structures can further include structural portions comprising non-conductive or semi-conductive materials extending in the Z direction to provide structural support for the conductive portions shown in FIG. 1. Such structures are more fully described below with respect to FIG. 3.

The drive portion 100 shown in FIG. 1 operates on the principle of electrostatic attraction between adjacent interdigitating fingers. That is, motion of the truss comb structure 104 can be generated by developing a voltage difference between the drive comb structure 102 and the truss comb structure 104. In the case of device 100, the voltages applied at comb structures 102 and 104 are also seen at fingers 106 and 108, respectively. The resulting voltage difference generates an attractive force between fingers 106 and fingers 108. If the generated electrostatic force between fingers 106 and finger 108 is sufficiently large to overcome the other forces operating on truss comb structure 104 (such as a spring constant of elastic component 110), the electrostatic force will cause the motion of the truss comb structure 104 between a first interdigitated position (resting position at a zero voltage difference) and a second interdigitated position (position at a non-zero voltage difference) among motion axis 105. Once the voltage difference is reduced to zero, elastic component 110 restores the position of truss comb structure 104 to the first interdigitating position.

As shown in FIG. 1, each finger 108 in truss comb structure 104 can be disposed between two fingers 106 of drive comb structure 102. Accordingly, an electrostatic force is generated on both sides of finger 108 when a voltage difference is developed between comb structures 102 and 104. Therefore, to ensure movement of truss comb structure 104 in only one direction in response to a voltage difference, fingers 108 are positioned with respect to fingers 106 such that the electrostatic force in the a first direction along the X-axis is greater than the electrostatic force in an opposite direction in the X-axis. This is accomplished by configuring the finger spacing (i.e., spacing between fingers of interdigitated comb structures) in the first direction along the X-axis (x₀) and the finger spacing in the opposite direction along the X-axis (y₀) to be different when the voltage difference is zero. Since the amount of electrostatic force is inversely proportional to the distance between fingers, the motion of truss comb structure will be in the direction associated with the smaller of x₀ and y₀. In the exemplary embodiments of the invention described below, x₀ will be used to identify the smaller of x₀ and y₀

The drive portion illustrated in FIG. 1 provides a control mechanism for horizontal actuation in a MEMS device that can be precisely controlled by adjusting the voltage difference between the drive and truss comb structures. This allows the same general configuration to be used for both switching between two positions (by alternating between a first and second voltage difference) and for adjusting continuously over a range of interdigitating positions (by adjusting the voltage continuously over a voltage range). Consequently, the drive portion in FIG. 1 can be used for toggling devices or for operating adjustable devices.

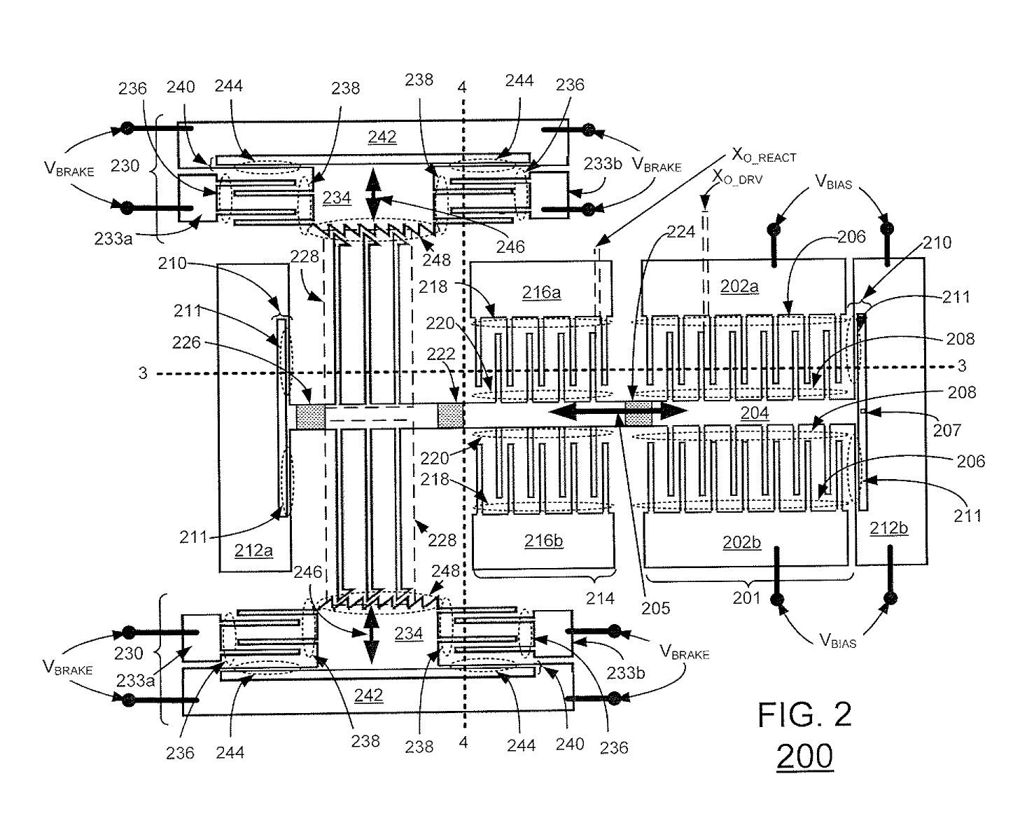

The drive portion described above could be coupled to any variety of devices. Still such a drive portion for various types of devices will only provide a partial improvement in manufacturing robustness and device reliability. In general, the robustness of the IC fabrication techniques used for fabricating MEMS and other types of devices is increased by reducing the variety of feature types and dimensional variation in each layer. The various embodiments of the invention exploit this characteristic. In particular, another aspect of the invention is to use the comb structure drive portion in conjunction with a comb structure based reactive portion to provide device functionality for a filter. Therefore, in the various embodiments of the invention, one structure that can be used to provide a variety of devices is shown below in FIG. 2.

FIG. 2 shows a top view of an exemplary MEMS device 200 which can be adapted for use as one or more types of MEMS-based devices in accordance with an embodiment of the invention. As shown in FIG. 2, device 200 includes a drive portion 201, similar to the drive portion 100 described above with respect to FIG. 1. That is, drive portion 201 includes device drive comb structures 202a and 202b (collectively 202), a device truss comb structure 204, drive fingers 206, and truss fingers 208.

Device truss comb structure 204 also includes elastic portions 210 with fixed ends 212a and 212b (collectively 212). In the exemplary embodiment shown in FIG. 2, elastic portions 210 comprise elastic or flexible reed structures 211 mechanically coupling device truss comb structure 204 to fixed ends 212. Therefore, a leaf spring structure is effective formed on the two ends of device truss comb structure 204. In operation, as a force is exerted on device truss comb structure 204 (by generating a voltage difference between fingers 206 and 208, the reed structures 211 deform to allow device truss comb structure 204 to move along motion axis 205 from a first interdigitated position to at least a second interdigitated position. Once the force is no longer being exerted, the reed structures 211 apply a restorative force to restore the position of the device truss comb structure 204 to a first interdigitated position. In the various embodiments of the invention, motion of device truss comb structure 204 along motion axis 205 will result in the spacing between fingers 206 and 208 and between fingers 218 and 220 to change together. Thus, adjustment of the spacing between fingers 206 and 208 using a bias voltage can be used to control the spacing between fingers 218 and 220.

In addition to the drive portion 201, MEMS horizontal GCA devices in accordance with the various embodiments of the invention also provide a reactive portion 214, as shown in FIG. 2. The reactive portion 214 includes input/output comb structures 216a and 216b (collectively 216) having a fixed position. The input/output comb structures 216 can also have one or more sense fingers 218 extending therefrom. To interact with reactive portion 214, the device truss comb structure 204 can additionally include one or more additional truss fingers 220 extending therefrom and interdigitating sense fingers 218. Therefore, the device truss comb structure 204 interdigitates (via fingers 208 and fingers 220) both the drive fingers 206 and the sense fingers 218. As a result, the device truss comb structure 204 couples and is part of both the drive portion 201 and reactive portion 214.

In addition to the drive portion 201 and the reactive portion 214, MEMS horizontal GCA devices in accordance with the various embodiments of the invention also include at least one brake portion 230 for fixing a lateral position of device truss comb structure 204. As shown in FIG. 2, brake portion 230 is configured similar to the drive portion 100 described above with respect to FIG. 1. That is, brake portion 230 includes a brake drive comb structures 233a and 233b (collectively 233), a brake truss comb structure 234, brake drive fingers 236, and brake truss fingers 238. Brake truss comb structure 234 also includes brake elastic portions 240 with a brake fixed end 242. In the exemplary embodiment shown in FIG. 2, the brake elastic portions 240 also comprise elastic or flexible brake reed structures 244 mechanically coupling brake truss comb structure 234 to brake fixed end 242. Therefore, a leaf spring structure is also effectively formed in brake portion 230. Further, as shown in FIG. 2, brake portion 230 is arranged so that a motion axis 246 of brake truss comb structure 234 is substantially perpendicular to a motion axis 205 of device truss comb structure 204.

In the various embodiments of the invention, motion of brake truss comb structure 234 along motion axis 246 will result in the spacing between fingers 236 and 238 to change. Thus, adjustment of the spacing between fingers 236 and 238 using a brake bias voltage (V_{BRAKE}) can be used to move the brake comb structure from a brake position to a release position.

The brake portion 230 and device truss comb structure 204 are configured to mechanically engage via a series of engagement features. For example as shown in FIG. 2, device truss comb structure 204 includes truss engagement features 228 extending towards brake truss comb structure 234. Brake truss comb structure 234 includes brake engagement features 248 extending towards device truss comb structure 204 and engagement features 228. Thus, when the brake truss comb structure 234 is in a brake position, the brake engagement features 248 physically engage with the truss engagement features 228 and prevent further motion of device truss comb structure 204.

As shown in FIG. 2, the brake engagement features 248 and the truss engaging features 228 can be configured to provide corresponding sawtooth patterns that engage regardless of the position of the device truss comb structure 204 along motion axis 205. However, the various embodiments of the invention are not limited in this regard. Rather, the brake engagement features 248 and the truss engagement features 228 can be configured to utilize corresponding patterns that provide a sufficient frictional force therebetween to prevent the restorative force of elastic portions 210 to move device truss comb structure 204 once V_{BIAS} is no longer being applied. Other examples of such patterns are sine patterns, square or rectangular patterns, and triangular patterns, to name a few.

In operation, device 200 operates to adjust a position of device truss comb structure 204 along motion axis 205 as described below. In some embodiments, a force can be first exerted on brake truss comb structure 234 (by generating a voltage difference V_{BRAKE} between fingers 236 and 238 to cause the reed structures 244 deform and allow brake truss comb structure 234 to move along the brake motion axis 244 from a brake position to release position. That is, the brake truss comb structure 234 is moved towards brake fixed end 242 to separate the brake engagement features 248 and the truss engaging features 228. Second, a force is exerted on device truss comb structure 204 (by generating a voltage difference V_{BIAS} between fingers 206 and 208 to cause the reed structures 211 to deform) to allow device truss comb structure 204 to move in a first direction along motion axis 205 (towards fixed end 212b) to a different interdigitated position. Alternatively, a force on device truss comb structure 204 can be reduced (by generating a lower or zero voltage difference between fingers 206 and 208 to cause the reed structures 211 to undeform) to allow device truss comb structure 204 to move in an opposite direction along motion axis 205 (towards fixed end 212a) to a different interdigitated position.

Once a desired interdigitated position for device truss comb structure 204 is achieved, the force on brake truss comb structure 234 is removed, i.e., by removing the voltage difference V_{BRAKE} between fingers 236 and 238. Once the force is no longer being exerted on brake truss comb structure 234, the brake reed structures 244 apply a restorative force to restore the position of the brake device truss comb structure 234 to the brake position. In the brake position, the brake engagement features 248 and the truss engaging features 228 mechanically engage and retain device truss comb structure 204 in a position along motion axis 205. Afterwards, the force on device truss comb structure 204 can also be removed, i.e., by removing the voltage difference between fingers 206 and 208. However, since the brake engagement features 248 and the truss engaging features 228 are physically engaging and provide a frictional force greater than a restorative force of reed structure 211, the position of device truss comb structure 204 remains fixed at the position associated with the V_{BIAS} originally applied.

In other embodiments, the truss engagement features 228 and the brake engagement features 248 can be designed to allow in one or both directions along motion axis 205 without the need to apply a force to the brake truss comb structure 234. For example, as shown in FIG. 2, the sawtooth patterns of the truss engagement features 228 and the brake engagement features 248 permit motion of device truss comb structure 204 in a direction toward fixed end 212b. To restore the position of the moveable device truss comb structure 204 or to adjust the position in a direction towards fixed end 212a, the brake portion 230 can be released using V_{BRAKE}, as described above. In another example, a sine pattern or a triangular pattern would allow motion in both directions. In any of these embodiments, the electrostatic force between fingers 206 and 208 must there be sufficient to overcome both the restorative force of elastic portions 210 and the frictional force between the truss engagement features 228 and the brake engagement features 248.

The operation and configuration of components 202-212 and 233-244 is substantially similar to that of components 102-112 in FIG. 1. Therefore the discussion in FIG. 1 is sufficient for describing the operation and configuration for components 202-212 and 233-244 in FIG. 2.

In the embodiment shown in FIG. 2, fingers 206, 208, 218, 220, 236, and 238 are shown to be similarly dimensioned and having a similar amount of overlap. Although, device 200 can be configured to include comb structures having multiple sets of fingers that have the same dimensional relationships in the drive, reactive, and brake portions, the invention is not limited in this regard. Rather, the dimensional relationships can be different in these various portions. Furthermore, the dimensional relationship can also vary within each portion. In addition, the overall dimensions and arrangements of the drive, reactive, and brake portions can also vary in the various embodiments of the invention. For example, although portions 201, 204, and 230 are shown in FIG. 2 in a particular sequence with respect to device truss comb structure 204, the invention is not limited in this regard. Rather portions 201, 204, and 230 can be arranged in other sequences with respect to device truss comb structure 204. In another example, although brake portions 230 are shown are being positioned outside a perimeter defined by fixed ends 212b, drive portion 201, and reactive portion 214, the invention is not limited in this regard. In some embodiments of the invention, the brake portion can be sized and positioned to also fall within this perimeter. Such a configuration can be advantageous since a shorter length for truss engagement features 228 increases the stiffness of these features. Thus, the likelihood of failure or shift in position over time (due to fatigue or inelastic deformation) is substantially reduced.

Additionally, as described above with respect to FIG. 1, the comb structures 202, 204, 216, 233, and 234 can further include conductive portions and structural portions, comprising non-conductive or semi-conductive materials, to provide structural support for the conductive portions. The relationship between these portions will be described below in greater detail with respect to FIG. 3.

As described above, motion of device truss comb structure 204 along motion axis 205 is generated by developing a voltage difference in drive portion 201. In particular, by developing a voltage difference between across fingers 206 and 208 by apply a voltage across device drive comb structures 202 and device truss comb structure 204. The voltage difference causes the finger spacing (x₀_{_{—}}_{DRY}) between fingers 206 and 208 to vary, which is translated into motion of device truss comb structure 204 along motion axis 205. The result of this motion of the device truss comb structure 204 is the motion of fingers 220 with respect to fingers 218. Accordingly, based on the voltage difference between device drive comb structures 202 and device truss comb structure 204, the finger spacing between fingers 218 and 220 (X₀_{_{—}}_{REACT}) can be varied. In some embodiments of the invention, a stopper 207 can be used to limit the amount of motion of device truss comb structure 204 and prevent either X₀_{_{—}}_{REACT} and/or X₀_{_{—}}_{DRV} from going to zero. A similar stopper can be used in brake portion 230 to limit the amount of motion of brake truss comb structure 234.

The structure shown in FIG. 2 can be fabricated using various IC and/or MEMS fabrication techniques. This is illustrated in FIGS. 3A-3C. FIGS. 3A-3C show partial cross-sections of device 200 through cutline 3-3 in FIG. 2 during various steps of a fabrication process in accordance with the various embodiments of the invention. It is worth noting that a similar set of cross-sections would be observed through cutline 4-4.

Manufacture of device 200 begins with the formation of the various layers used to form the structures in FIG. 2. As shown in FIG. 3A, this includes at least one base layer 302, at least one release layer 304 formed on base layer 302, at least one structural layer 306 formed on release layer 304, a lower conductive layer 308, and an upper conductive layer 309 formed on structural layer 306. The upper conductive layers 309 can one or more metal layers. The lower conductive layers 308 can comprise one or more adhesion layers to improve adhesion between upper conductive layers 309 and structural layer 306. However, in some embodiments, lower conductive layers 308 can be omitted. The materials for layers 304-309 can be formed on base layer 302 in a variety of ways, including thermal oxidation, physical/chemical deposition, sputtering, and/or electroplating processes, depending on the type and composition of the layer being formed.

In the various embodiments of the invention, the composition of structural layer 306 is selected such that it is electrically non-conductive. Furthermore, the composition of release layer 304 is selected such that it can be selectively removable, with respect to base layer 302, structural layer 306, and conductive layers 308, 309, using at least one removal process. For example, in some embodiments of the invention, layers 302-306 are provided by using a silicon on insulator (SOI) substrate. In such a substrate, the silicon oxide comprising layer sandwiched between two layers of silicon provides release layer 304 between the silicon-comprising base layer 302 and structural layer 306. One of ordinary skill in the art will recognize that various types of etch processes are readily available for removing silicon oxide comprising materials without substantially removing silicon comprising materials. However, the invention is not limited to SOI substrates. In other embodiments of the invention, the release layer 304 and structural layer 306 are formed on a silicon substrate that provides base layer 302. In still other embodiments, non-silicon comprising materials are used for forming layers 302-306.

Once layers 302-309 are formed, formation of the structures for device 200 can begin. In general, the structures shown in FIG. 3B for device 200 are formed by creating voids in conducting layers 308, 309, structural layer 306, and release layer 304. This step can be performed in a variety of ways. For example, as shown in FIG. 3B, a masking layer 310 can be formed on layer 309, having a mask pattern in accordance with the structures in device 200. For example, the portion of masking layer 310 shown in FIG. 3B shows the mask pattern for portions of reed structure 211, fixed end 212b, fingers 206, and fingers 208. Once the mask pattern is formed in masking layer 310, various dry and/or wet etching processes are used to transfer the mask pattern into conducting layers 308, 309 and structural layer 306.

Although the exemplary mask pattern shown in FIG. 3B provides for the same pattern to be transferred into both conducting layers 308, 309 and structural layer 306, the various embodiments of the invention are not limited in this regard. In some embodiments of the invention, two masking steps are performed. For example, a first mask pattern can be provided for etching conducting layers 308. Afterwards a second mask pattern is provided for etching structural layer 306.

Once the masking pattern has been transferred into structural layer 306, portions of release layer 304 are removed to “release” at least some portions of device truss comb structure 204. This can be accomplished by providing an isotropic selective removal process to device 200. An isotropic process not only removes the exposed portions of release layer 304, but will also removes portions of release layer 304 (i.e., creates voids) beneath structural layer 306 in the vicinity of openings in structural layer 306 (i.e., undercut these structures). If the lateral dimensions of features in structural layer 304 are small enough (such as under reed structures 211, fingers 206, and fingers 208 shown in FIGS. 3A-C), all portions of the release layer 304 underneath such features will be removed. This process thus leaves such features free-standing or “released”. These features will then only remain connected to other portions of device 200 via connections in other layers. For example, as shown in FIG. 3C, the portions of release layer 304 underneath portions of structural layer 306 associated with reed structures 211, fingers 206, and fingers 208 are removed. Still these features are attached to device 200 via other portions of structural layer 306 and/or conductive layers 308, as shown in FIG. 2. In one exemplary configuration, such structures can be realized by utilizing an SOI substrate and a hydrofluoric (HF) acid-based etch. First an etch process is used to form the voids shown in FIG. 3B. Afterwards, an HF acid-based etch process is used to selectively remove and undercut portions of the silicon oxide comprising layer, creating voids beneath selected features of device 200, to result in the structure shown in FIG. 3C.

The various embodiments of the invention are not limited to the exemplary manufacturing process described above. For example, in some embodiments of the invention, atomic layer epitaxial (ALE) processes are used to form conductive layers 308, 309 after etching of structural layer 306 and removal of release layer 304. In such embodiments, use of ALE process allows precise control of placement and thickness of conductive layer. As a result, device control can be improved since the dimensions of the active portions of the horizontal GCA device can be constructed with higher precision.

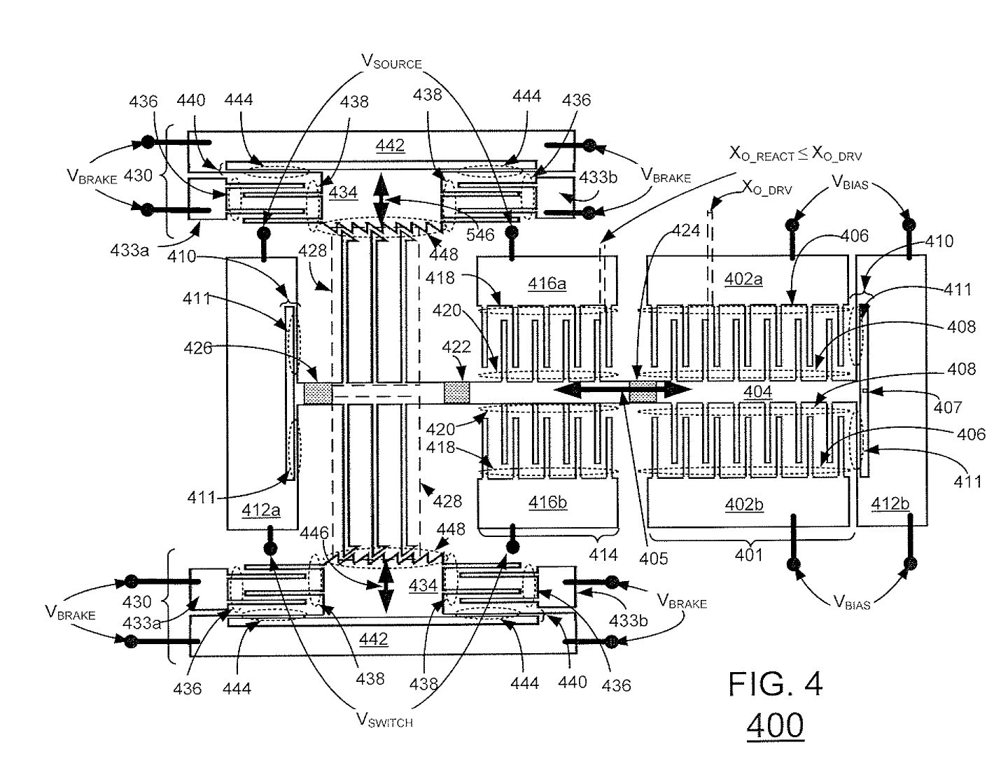

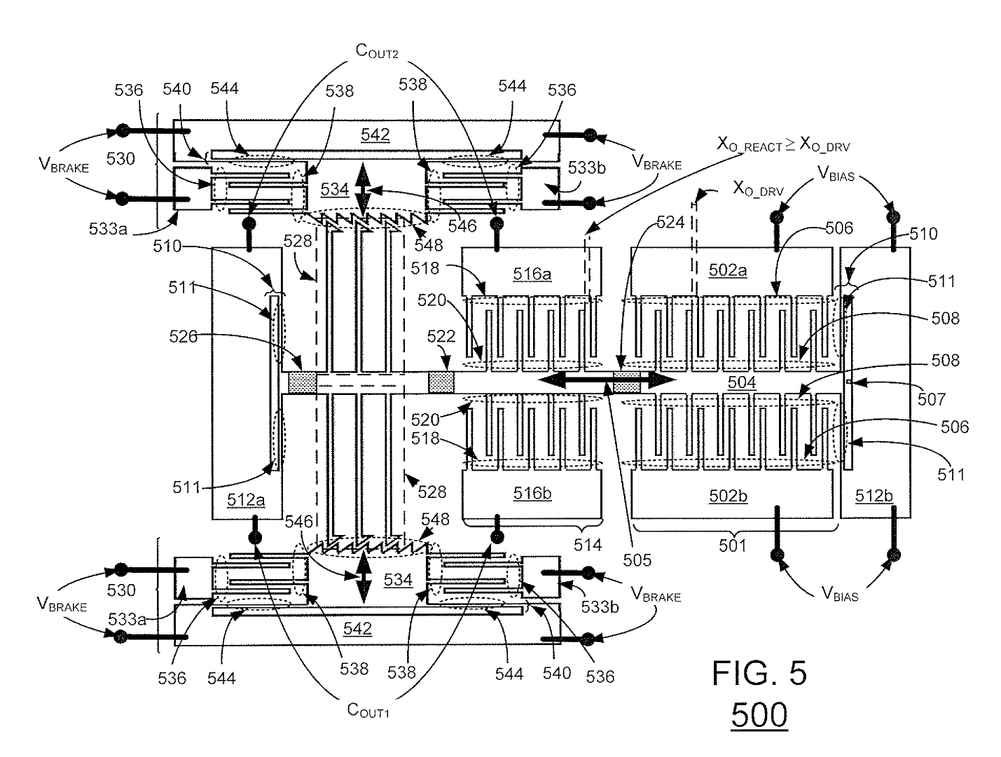

As described above, device 200 can be easily modified to provide various types of devices. In particular, by varying X₀_{_{—}}_{REACT} relative to X₀_{_{—}}_{DRV}. For example, device 200 can be operated as a switch or an adjustable capacitor depending on the difference between X₀_{_{—}}_{REACT} and X₀_{_{—}}_{DRV}, as shown in FIGS. 4 and 5, respectively.

FIG. 4 shows a top view of an exemplary MEMS comb device 400 adapted for use as a horizontal GCA switch device in accordance with an embodiment of the invention. Similar to device 200, device 400 includes a drive portion 401, a reactive portion 414, a brake portion 430, and other components, similar to device 200 in FIG. 2. Therefore, the description above for components 201-248 is sufficient for describing the general operation of components 401-448 in FIG. 4.

As described above, device 400 is configured for operating as a switch without significant changes in design, manufacture, and operation principles as compared to device 200 and other horizontal GCA devices in accordance with the various embodiments of the invention. That is, the device truss comb structure 404 is configured to electrically couple a first input/output comb structure 416a to a second input/output comb structure 416b. This can be accomplished by providing a configuration of the finger spacing between fingers 418 and 420 such that when the finger spacing between fingers 406 and 408 is reduced, fingers 418 and 420 come into contact to close the switch and to allow current to flow between input comb 416a and output comb 416b. In other words, a switch is provided when X₀_{_{—}}_{REACT}≦X₀_{_{—}}_{DRV}. As a result, the gap between fingers 420 and 418 is closed when device truss comb structure 404 moves at least a minimum amount due to a voltage difference with respect to device drive comb structure 402.

In addition to dimensioning the device drive comb structure 402 and the input/output comb structures 416 to allow contact of fingers 418 and 420, additional modifications of device 200 in FIG. 2 may be needed to operate device 400 as a switch. For example, as shown in FIG. 4, the input signal can be a voltage provided by a voltage source (V_{SOURCE}), thus requiring two input ports for the signal and the reference (e.g., ground). In device 400, this is provided by connecting the reference to fixed end 412a of device truss comb structure 404 and connecting the input signal to input comb 416a. The output voltage of the switch (V_{SWITCH}) can then be measured by measuring the voltage difference between output comb 416b and fixed end 412a.

The MEMS structures described above comprise electrically conductive layers supported by electrically non-conductive layers. Therefore, for device 400 to operate properly as a switch, some discontinuities in the conductive layer may be required for several reasons. First, if a voltage difference develops between fingers 418 and 420, the device truss comb structure 404 will also be subject to motion due to the electrostatic force generated between fingers 418 and 420. Second, when fingers 418 and 420 are brought into contact, the signal at input/output comb 416a needs to reach input/output comb 416b without being shorted to ground or some other reference point, such as fixed end 412a. Finally, when fingers 418 and 420 are brought into contact, the signal at input/output combs 416 should not interfere with the operation of drive portion 401. Similarly, the operation of brake portions 430 and truss engagement features 428 should also not interfere with the operation of drive portion 401 or the output of device 400. In particular, the voltage difference between fingers 406 and 408 should be only controlled by a voltage difference applied directed to fingers 406 and 408 and not be affected by the voltage at the input/output combs 416 or voltages in the brake portion 430.

Therefore, to avoid such issues in device 400, the electrically conductive layer on or in device truss comb structure 404 can be configured to have discontinuities, such as discontinuities 422, 424, and 426. The discontinuities 422-426 electrically isolate fixed end 412a, truss engagement features 428, fingers 420, and fingers 408 in device truss comb structure 404. Accordingly, any voltages in one portion of device 400 will not affect the operation of another portion of device 400.

In one embodiment of the invention, switch device 400 can operate as follows. An input signal, such as V_{SOURCE}, is applied between input comb 416a and fixed end 412a. To close the switch, a voltage difference V_{BRAKE} is first developed between fingers 436 and 438 to move the brake truss comb structure 434 to a release position to allow motion of device truss comb structure 404. Afterwards, a voltage difference is developed between fingers 406 and 408. For example, a voltage V_{BIAS} is applied between device drive comb structures 402 (which are electrically coupled to fingers 406) and fixed end 412b (which is electrically coupled to fingers 408). The amount of V_{BIAS} is selected to cause motion of device truss comb structure 404 along motion axis 405 that is sufficient to move fingers 420 into contact with fingers 418, thus closing the switch. For example, V_{BIAS} is selected to create an electrostatic force greater than the restorative force of reed structures 411. Once the desired motion of device truss comb structure 404 is achieved, V_{BRAKE} can be reduced to move the brake truss comb structure 434 to a brake position to fix the position of device truss comb structure 404. Thereafter, V_{BIAS} can be reduced. However, the brake portion 430 acting on the device truss comb structure 404 maintains the switch in a closed position without consuming additional power.

To open the switch, a voltage difference V_{BRAKE} is first developed between fingers 436 and 438 to move the brake truss comb structure 434 to a release position to allow motion of device truss comb structure 404. Further, no V_{BIAS} is applied between device drive comb structures 402 (which are electrically coupled to fingers 406) and fixed end 412b (which is electrically coupled to fingers 408). As a result, the restorative force of elastic portions 410 restores a position of device truss comb structure 404, separating fingers 418 and 420, opening switch. Thereafter, V_{BRAKE} can be reduced to move the brake truss comb structure 434 to a brake position to fix the position of device truss comb structure 404. The brake portion 430 acting on the device truss comb structure 404 thus maintains the switch in an open position until an additional V_{BRAKE} and V_{BIAS} are applied to device 400.

In other embodiments, the truss engagement features 428 and the brake engagement features 448 can be designed to allow switch device 400 to be closed without the need to apply a force to the brake truss comb structure 434, as described above with respect to FIG. 2. For example, as shown in FIG. 4, the sawtooth patterns of the truss engagement features 428 and the brake engagement features 448 permit motion of device truss comb structure 404 in a direction toward fixed end 412b. Therefore, by applying an electrostatic force between fingers 406 and 408, using V_{BIAS}, that sufficient to overcome both the restorative force of elastic portions 410 and the frictional force between the truss engagement features 428 and the brake engagement features 448, the device truss comb 404 structure can be fixed in a position in which fingers 418 and 420 are in contact without the need to apply V_{BRAKE}. Thereafter, to open switch device 400, the brake portion 430 can be released using V_{BRAKE}, as described above. In another example, a sine pattern or a triangular pattern can be used for device 400 to allow motion in both directions. In such an embodiment, the switch can be opened using V_{BRAKE}, as described above, or by applying negative V_{BIAS} to separate fingers 418 and 420.

In some embodiments of the invention, the position and arrangement of the truss engagement features 428, the brake engagement features 448, and fingers 418 and 420 can be designed such that the engagement features 428 and 448 position fingers 418 and 420 in electrical contact. However, due to manufacturing variations, the arrangement in FIG. 4 can result in poor or no electrical contact between fingers 418 and 420. Accordingly, in some embodiments of the invention, fingers 418 or fingers 420 can be arranged such that one of fingers 418 and 420 such that at least one of fingers 418 and 420 deforms when in contact. As a result, even if the dimensions and spacing of the truss engagement features 428, the brake engagement features 448, and fingers 418 and 420 vary due to manufacturing variations, the deformation of one of fingers 418 and 420 against the other will ensure a good electrical contact. In such embodiments, this can be achieved in several ways. For example, at least one of fingers 418 and 420 can have at least one portion that is non-parallel to the other of fingers 418 and 420. In another example, at least one of fingers 418 and 420 can have a contact projection extending towards the other of fingers 418 and 420. However, the invention is not limited in this regard and other configurations of fingers 418 and 420 can be provided to ensure a good electrical contact therebetween.

As described above, the device 200 can also be configured to provide functionality as another type of device, such as an adjustable capacitor or varactor, also without significant changes in design, manufacture, and operation principles. This is illustrated below with respect to FIG. 5. FIG. 5 shows a top view of an exemplary MEMS comb device 500 adapted for use as a horizontal GCA varactor device for a filter bank in accordance with an embodiment of the invention. As described above, device 500 includes a drive portion 501, a reactive portion 514, a brake portion 530, and other components, similar to in FIG. 2. Therefore, the description above for components 201-248 is sufficient for describing the general operation of components 501-548 in FIG. 5.

As described above, device 500 is configured for operating as a varactor. In particular, the device truss comb structure 504 is configured to provide an adjustable capacitor based on adjustment of the gap between a first capacitor plate, provided by fingers 518, and a second capacitor plate, provided by fingers 520. Therefore, device 500 forms a first capacitor between comb structure 516a and device truss comb structure 504, with a capacitance of C_{OUT1}, and a second capacitor between comb structure 516b and device truss comb structure 504, with a capacitance of C_{OUT2}.

As described above, device 500 is configured for operating as a varactor without significant changes in design, manufacture, and operation principles. That is, the device truss comb structure 504 is configured to adjust the finger spacing between fingers 518 and 520 as the finger spacing between fingers 506 and 508 is reduced. However, to maintain proper operation of the varactor, the fingers 518 and 520 should not come into contact to allow current to flow between comb structure 516a and comb structure 516b. Therefore, in the various embodiments of the invention, x₀_{_{—}}_{REACT}≧X₀_{_{—}}_{DRV} in a varactor device to ensure that even if fingers 506 and 508 come into contact, a gap is maintained between fingers 520 and 518.

In the various embodiments of the invention, these first and second capacitors can be connected in various ways to provide capacitances in series or parallel. For example, to provide a series capacitance, the capacitance can be measured between comb structures 516a and 516b. In contrast to provide a parallel capacitance, the capacitance can be measure between comb structures 516a, 516b and fixed end 512a (if electrically coupled to fingers 520).

As described above, the MEMS structures described above comprise electrically conductive layers supported by electrically non-conductive layers. Therefore, for device 500 to operate properly as a varactor, some discontinuities in the conductive layer may be required for several reasons. In particular, if a voltage difference develops between fingers 518 and 520, the device truss comb structure 504 will also be subject to motion due to the electrostatic force generated between fingers 518 and 520. Additionally, if fingers 506 and 508 are brought into contact, the signal in device drive comb structure 502 should not interfere with the operation of reactive portion 514. Similarly, the operation of brake portions 530 and truss engagement features 528 should also not interfere with the operation of drive portion 501 or the output of device 500. In particular, the voltage difference between fingers 506 and 508 should be only controlled by a voltage difference applied directed to fingers 506 and 508 and not be affected by the voltage at the input/output combs 516 or voltages in the brake portion 530.

Therefore, to avoid such issues in device 500, the electrically conductive layer on or in device truss comb structure 504 can be configured to have discontinuities, such as discontinuities 522, 524, and 526. The discontinuities 522-526 electrically isolate fixed end 512a, truss engagement features 528, fingers 520, and fingers 508 in device truss comb structure 504. Accordingly, any voltages in one portion of device 500 will not affect the operation of another portion of device 500.

Device 500 operates in one embodiment of the invention as follows. A circuit (not shown) is coupled to comb structures 516a, 516b, and fixed end 512a (if necessary, as described above). To provide an amount of capacitance, a voltage difference V_{BRAKE} is first developed between fingers 536 and 538 to move the brake truss comb structure 534 to a release position to allow motion of device truss comb structure 504. Thereafter, a voltage difference V_{BIAS} is developed between fingers 506 and 508 to generate electrostatic attraction between these fingers. For example, V_{BIAS} is applied across device drive comb structures 502 and fixed end 512b (which is electrically coupled to fingers 508) to cause sufficient electrostatic attraction between fingers 506 and 508 to induce motion of device truss comb structure 504, and consequently motion of fingers 520 towards fingers 518. The magnitude of V_{BIAS} is selected to provide a gap associated with a spacing between fingers 518 and 520, and consequently capacitance value. For example, to increase capacitance, V_{BIAS} is selected to create an electrostatic force that is at least greater than the restorative force of reed structures 511 to cause motion of device truss comb structure 504 along motion axis 505 and reduce a spacing between fingers 518 and 520. Once the desired motion of device truss comb structure 504 is achieved, V_{BRAKE} can be reduced to move the brake truss comb structure 534 to a brake position to fix the position of device truss comb structure 504. Thereafter, V_{BIAS} can be reduced. However, the brake portion 530 acting on the device truss comb structure 504 maintains the spacing between fingers 518 and 520, and thus a capacitance, without consuming additional power.

Afterwards, to change the capacitance, a voltage difference V_{BRAKE} is first developed between fingers 536 and 538 to move the brake truss comb structure 534 to a release position to allow motion of device truss comb structure 504. A different V_{BIAS} is then provided. If the new V_{BIAS} is less than the previous V_{BIAS}, the resulting electrostatic force will be less. Thus, the restoring force applied by reed structures 511 acts on device truss comb structure 504 to increase the gap between fingers 520 from fingers 518, and thus decrease the capacitance. If the new V_{BIAS} is greater than the previous V_{BIAS}, the resulting electrostatic force will be greater. Thus, the greater electrostatic force acts on device truss comb structure 504 to further decrease the gap between fingers 520 from fingers 518, and thus increase the capacitance. Once the desired motion of device truss comb structure 504 is achieved, V_{BRAKE} can be reduced to move the brake truss comb structure 534 to a brake position to fix the position of device truss comb structure 504. Thereafter, V_{BIAS} can be reduced. However, the brake portion 530 acting on the device truss comb structure 504 maintains the new spacing between fingers 518 and 520, and thus a capacitance, without consuming additional power.

In other embodiments, the truss engagement features 528 and the brake engagement features 548 can be designed to allow varactor device 500 to be adjusted without the need to apply a force to the brake truss comb structure 534, as described above with respect to FIG. 2. For example, as shown in FIG. 5, the sawtooth patterns of the truss engagement features 528 and the brake engagement features 548 permit motion of device truss comb structure 504 in a direction toward fixed end 512b. Therefore, by applying an electrostatic force between fingers 506 and 508, using V_{BIAS}, that sufficient to overcome both the restorative force of elastic portions 510 and the frictional force between the truss engagement features 528 and the brake engagement features 548, the device truss comb structure can be fixed in a position in which fingers 518 and 520 are in contact without the need to apply V_{BRAKE}. Thereafter, if a smaller capacitance is needed, the brake portion 530 can be released using V_{BRAKE} and device 500 can be readjusted, as described above. In another example, a sine pattern or a triangular pattern can be used for device 500 to allow motion in both directions. In such an embodiment, the capacitance be adjusted using V_{BRAKE}, as described above, by applying a new V_{BIAS} to adjust the position of fingers 518 and 520, or any combination thereof.

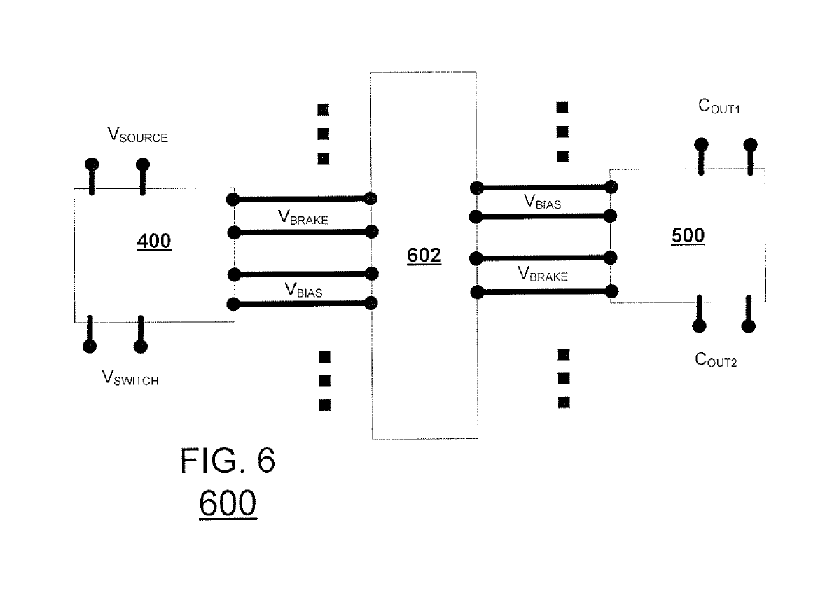

As described above, operation of a MEMS comb device in accordance with the various embodiments of the invention typically requires some coordination between the application of V_{BRAKE} and V_{BIAS}. In some embodiments of the invention, V_{BRAKE} and V_{BIAS} can be applied in the fashion described above by manually applying the voltages at the times needed. However, in other embodiments of the invention, V_{BRAKE} and V_{BIAS} can be applied automatically. This is illustrated below with respect to FIG. 6. FIG. 6 is a schematic diagram of a system 600 including MEMS comb devices in accordance with the various embodiments of the invention. As shown in FIG. 6, system 600 can includes one or more of devices 400, as described above with respect with respect to FIG. 4. Additionally, system 600 can also include one or more of devices 500, as described above with respect to FIG. 5.

In the various embodiments of the invention, the number and configuration of devices 400 and 500 can vary depending on the type of system. For example, a system 600 can be provided in which one of devices 400 and 500 is not present. In another example, system 600 can be configured to combine devices 400 and 500 to provide other types of devices, such as filters. However, the various embodiments of the invention are not limited in this regard and any configuration of devices 400 and/or 500 can be used.

As described above, timing of V_{BRAKE} and V_{BIAS} signals is generally needed to operate the devices 400 and/or 500 properly. As a result, when a large number of such devices are present, it can be difficult to manually operate each of these devices accurately to provide proper operation of system 600. Accordingly, in some embodiments of the invention, a controller 602 can be provided to coordinate the timing of V_{BRAKE} and V_{BIAS} signals and to coordinate the overall operation of devices in system 600.

Controller 602 can be implemented in a variety of ways. For example, controller 602 can be implemented as logic circuitry formed on a same substrate as one or devices 400 and 500. In another example, controller 602 can be implemented as one or more separate hardware devices including, but not limited to, application-specific integrated circuits, programmable logic arrays, and other hardware devices. Some embodiments implement functions in two or more specific interconnected hardware modules or devices with related control and data signals communicated between and through the modules, or as portions of an application-specific integrated circuit. Thus, controller 600 can be implemented using software, firmware, and/or hardware in the various embodiments of the invention.

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

The terminology used herein is for the purpose of describing particular embodiments only and is not intended to be limiting of the invention. As used herein, the singular forms “a”, “an” and “the ” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

What is claimed is:

1. A gap closing actuator (GCA) device, said GCA device comprising:
at least one device drive comb structure;
at least one input/output (I/O) comb structure defining an output of said GCA device;
at least one device truss comb structure interdigitating said device drive comb structure and said I/O comb structure, said device truss comb structure configured to move along a first motion axis between a plurality of interdigitated positions based on a first bias voltage applied between said device truss comb structure and said device drive comb structure; and
a brake portion configured for selectively physically engaging said device truss comb structure to fix a position of said device truss comb structure along said first motion axis.

2. The GCA device of claim 1, wherein said brake portion comprises:
at least one brake drive comb structure; and
at least one brake truss comb structure interdigitating said brake drive comb structure, said brake truss comb structure configured to move along a second motion axis between a brake position for said engaging of said device truss comb structure and one or more release positions for at least partially disengaging said device truss comb structure.

3. The GCA device of claim 2, wherein at least one of release positions is configured to completely disengage said device truss comb structure in response to a second bias voltage.

4. The GCA device of claim 2, wherein said second motion axis is substantially transverse to said first motion axis.

5. The GCA device of claim 1, wherein said brake portion further comprises a plurality of brake engagement features, and said device truss comb structure comprises at least one truss engagement feature having a shape and size corresponding to said brake engagement features.

6. The GCA device of claim 5, wherein said plurality of brake engagement features are arranged in least one of a sine pattern, a square pattern, a triangular pattern, and a sawtooth pattern.

7. The GCA device of claim 1, wherein a minimum finger spacing for said I/O comb structure and said device truss comb structure is greater than a minimum finger spacing said for said device drive comb structure and said device truss comb structure.

8. The GCA device of claim 1, wherein a minimum finger spacing for said I/O comb structure and said device truss comb structure is less than or equal to a minimum finger spacing said for said device drive comb structure and said device truss comb structure.

9. The MEMS device of claim 1, wherein said truss comb structure comprises at least one electrically conductive layer, and wherein said electrically conductive layer comprises a plurality of discontinuities for electrically isolating said device drive comb structure, said I/O comb structure, and said brake portion.

10. A method of manufacturing a micro-electro-mechanical (MEMS) device, comprising:
providing a substrate comprising a stack of layers, said stack comprising at least one base layer, at least one release layer on said base layer, and at least one structure layer on said release layer;
depositing at least one electrically conductive layer on said structure layer; and
forming a plurality of voids in said electrically conductive layer, said structure layer, and said release layer defining at least one device drive comb structure, at least one input/output (I/O) comb structure, at least one device truss comb structure interdigitating said device drive comb structure and said I/O comb structure, and a brake portion, said forming further comprising selecting said plurality of voids to further configure said device truss comb structure for selectively moving along a first motion axis between a plurality of interdigitated positions and to further configure said brake portion for selectively moving to physically engage said device truss comb structure.

11. The method of claim 10, wherein said forming further comprises selecting said plurality of voids to further define for said brake portion at least one brake drive comb structure, and at least one brake truss comb structure interdigitating said brake drive comb structure, said brake truss comb structure configured to move along a second motion axis between at least a brake position for said engaging of said device truss comb structure and one or more release positions for at least partially disengaging said device truss comb structure.

12. The method of claim 11, wherein said forming further comprises selecting said plurality of voids to further define said second motion axis to be substantially transverse to said first motion axis.

13. The method of claim 10, wherein said forming further comprises selecting said plurality of voids defining said brake portion to further define a plurality of brake engagement features, and selecting said plurality of voids defining said device truss comb structure to further define at least one truss engagement feature having a shape and size corresponding to said brake engagement features.

14. The method of claim 13, further comprising selecting said plurality of brake engagement features to be arranged in least one of a sine pattern, a square pattern, a triangular pattern, and a sawtooth pattern.

15. The method of claim 10, wherein said forming said plurality of voids further comprises selecting a minimum finger spacing for said I/O comb structure and said device truss comb structure that is greater than a minimum finger spacing said for said device drive comb structure and said device truss comb structure.

16. The method of claim 10, wherein said forming said plurality of voids further comprises selecting a minimum finger spacing for said I/O comb structure and said device truss comb structure that is less than a minimum finger spacing said for said device drive comb structure and said device truss comb structure.

17. The method of claim 10, wherein said forming said plurality of voids further comprises selecting said plurality of voids to define a plurality of discontinuities in said electrically conductive layer for electrically isolating said device drive comb structure, said I/O comb structure, and said brake portion.

18. A system comprising:
a plurality of gap closing actuator (GCA) devices, each of said plurality of GCA devices comprising:
at least one device drive comb structure,
at least one input/output (I/O) comb structure defining an output,
at least one device truss comb structure interdigitating said device drive comb structure and said I/O comb structure, said truss comb structure configured to move along a first motion axis between a plurality of interdigitated positions based on a first bias voltage applied between said device truss comb structure and said device drive comb structure, and
a brake portion configured for selectively physically engaging said device truss comb structure to fix a position of said device truss comb structure along said first motion axis; and
a control element configured for providing at least said first bias voltage to said GCA device.

19. The system of claim 18, wherein said brake portion comprises:
at least one brake drive comb structure; and
at least one brake truss comb structure interdigitating said brake drive comb structure, said brake truss comb structure configured to move along a second motion axis between a brake position for said engaging of said device truss comb structure and one or more release positions for at least partially disengaging said device truss comb structure.

20. The system of claim 19, wherein at least one of said release positions is configured to completely disengage said device truss comb structure in response to a second bias voltage.

21. The system of claim 20, wherein said control element is configured for providing said second bias voltage prior to said first bias voltage and terminating said second bias voltage prior to terminating said first bias voltage.

22. The system of claim 19, wherein said second motion axis is substantially transverse to said first motion axis.

23. The system of claim 18, wherein said brake portion further comprises a plurality of brake engagement features, and said device truss comb structure comprises at least one truss engagement feature having a shape and size corresponding to said brake engagement features.

24. The system of claim 22, wherein said plurality of brake engagement features are arranged in least one of a sine pattern, a square pattern, a triangular pattern, and a sawtooth pattern.

25. The system of claim 19, wherein said I/O comb structure and said device truss comb structure of at least one of said plurality of CGA devices is configured to provide a switch device.

26. The system of claim 19, wherein said I/O comb structure and said device truss comb structure of at least one of said plurality of CGA devices is configured to provide a varactor device.
